(19) United States
(12) Patent Application Publication
(10) Pub. No.: US 2022/0024642 A1
(43) Pub. Date: Jan. 27, 2022

(54) REUSABLE SILICONE FOOD STORAGE BAG WITH LATCHES

(71) Applicant: Hongyuan Han, New Vernon, NJ (US)

(72) Inventor: Hongyuan Han, New Vernon, NJ (US)

(21) Appl. No.: 17/381,442

(22) Filed: Jul. 21, 2021

Related U.S. Application Data
(60) Provisional application No. 63/055,441, filed on Jul. 23, 2020.

(51) Int. Cl. B65D 33/24; B65D 33/16

(52) U.S. Cl. CPC B65D 33/24; B65D 33/1675

(57) ABSTRACT

A food storage bag is described. The food storage bag includes a bag portion configured to receive contents for storage and a frame portion configured fasten close the bag portion with an airtight seal. The bag portion includes a retaining structure configured to securely attach the bag portion to the frame portion. The frame portion is configured to securely hold opposing interior sides of the bag portion in order to form the airtight seal. The bag portion may be made of silicone and the frame portion may be made of Polypropylene plastic.

### STATEMENT REGARDING FEDERALLY SPONSORED RESEARCH OR DEVELOPMENT

N/A

### BACKGROUND OF THE INVENTION

Various embodiments relate generally to storage bags and, more specifically, relate to reusable food storage bag with latches.

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

Many food storage options focus on disposable bags which can cause a negative environmental impact. What is needed is an ecologically-friendly, food storage alternative.

### BRIEF SUMMARY OF THE INVENTION

The below summary is merely representative and non-limiting.

The above problems are overcome, and other advantages may be realized, by the use of the embodiments.

In a first aspect, an embodiment provides a food storage bag. The food storage bag includes a bag portion configured to receive contents for storage and a frame portion configured fasten close the bag portion with an airtight seal. The bag portion includes a retaining structure configured to securely attach the bag portion to the frame portion. The frame portion is configured to securely hold opposing interior sides of the bag portion in order to form the airtight seal. The bag portion may be made of silicone.

### BRIEF DESCRIPTION OF THE SEVERAL VIEWS OF THE DRAWINGS

Aspects of the described embodiments are more evident in the following description, when read in conjunction with the attached Figures.

FIG. 1 shows a resealable storage bag in accordance with an embodiment.

FIG. 2 shows the side of the resealable storage bag of FIG. 1.

FIG. 3 shows the top of the resealable storage bag of FIG. 1.

FIG. 4 shows a view of the resealable storage bag of FIG. 1 with the frame separated from the bag section.

FIG. 5 shows the resealable storage bag of FIG. 1 with the latches opened.

FIG. 6 shows the side of the resealable storage bag of FIG. 1 with the bag and frame opened.

FIG. 7 shows the top of the resealable storage bag of FIG. 1 with the bag opened.

FIG. 8 shows another view of the resealable storage bag of FIG. 1 with the bag opened.

### DETAILED DESCRIPTION OF THE INVENTION

This patent application claims priority from U.S. Provisional Patent Application No. 63/055,441, filed Jul. 23, 2020, the disclosure of which is incorporated by reference herein in its entirety.

Various embodiments provide an ecologically friendly replacement to disposable plastic bags. Reusable silicone food storage bags are a healthy alternative for those who want to make a positive impact on the environment.

In some embodiments, the storage bag may be made of heat-safe plastic (such as Polypropylene) and silicone. These materials are heat safe to 400 degrees Fahrenheit. The storage bag features an the airtight and leak-proof design. Latches may be opened to allow air pressure to escape during heating. Additionally, these materials may be BPA & FDA food safe.

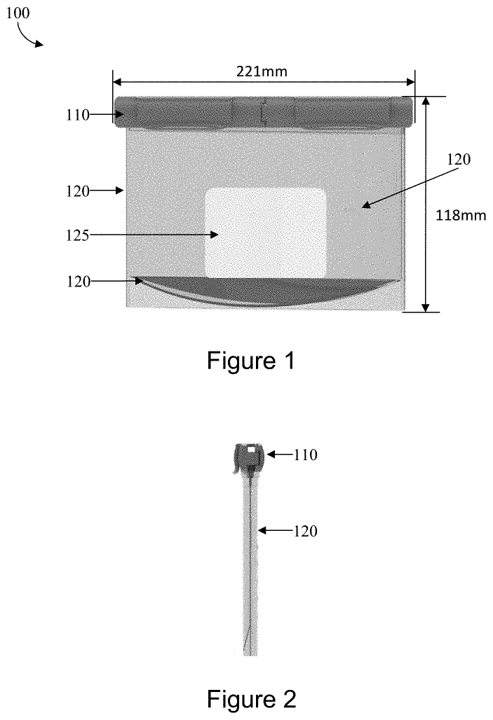

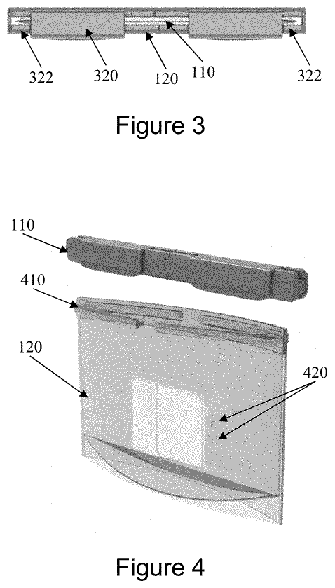

FIGS. 1-3 show a resealable storage bag 100 in accordance with an embodiment and The resealable storage bag 100 includes a bag section 120 which may be made of silicone. The bag section 120 may include graduation marks 420 and a viewing window 125 of relatively clear silicone. Some reusable silicone food storage bags have a bottom fold 130 that allows them to stand up while being filled and are safe in the oven, microwave, freezer, refrigerator and dishwasher.

The frame 110 includes multiple sections 320, 322 which enable allow the resealable storage bag to be securely closed. When closed, the frame 110 forces opposite sides of the bag section 120 together in an air/liquid-tight seal. The frame 110 may include paired sections, such as latch sections 320 and recess sections 520.

In this embodiment, the frame 110 includes multiple sections 322 which are hinged so as to allow the user to spread the sides open in order for the bag 120 to receive contents. In other non-limiting embodiments, the frame 110 may include alternative structures, such as a flexible frame.

FIG. 4 shows a view of the resealable storage bag 100 of FIG. 1 with the frame 110 separated from the bag section 120. The bag section 120 may include structures, such as a raised element 410, which secures the frame 110 to the bag section 120. In one embodiment, the frame 110 may include a shaped recess configured to receive and retain the raised element 410.

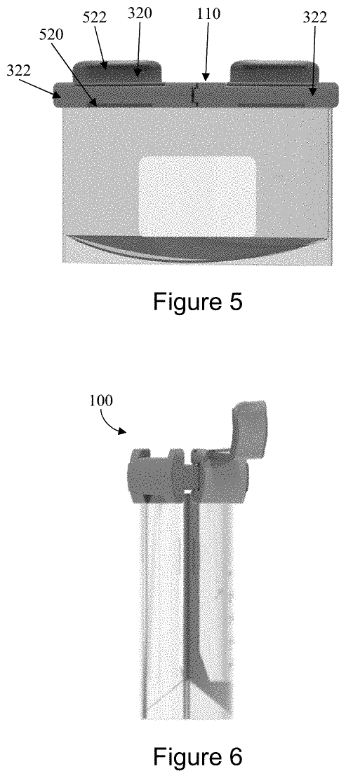

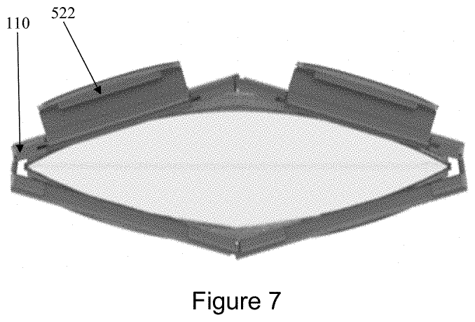

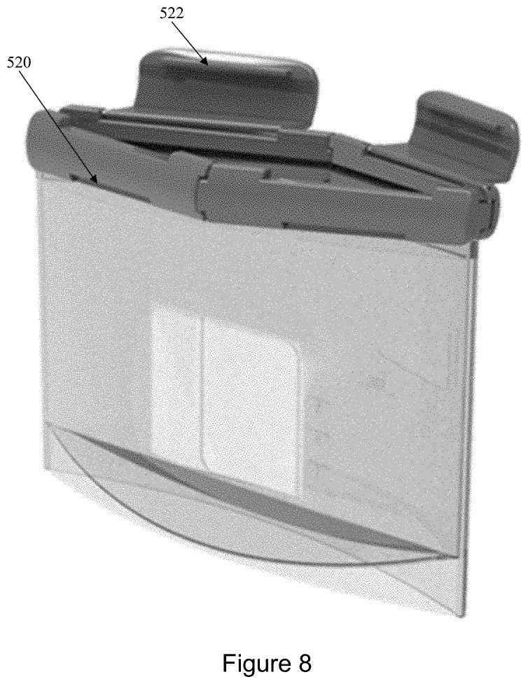

FIGS. 5-8 show the resealable storage bag 100 of FIG. 1 the bag 120 and frame 110 opened. As shown, the latch 320 include sealing structures such as protrusions 522 (e.g., molded extrusions) which fit into recesses 520 on either side of the frame 110 and prevent the storage bag 100 from opening unexpectedly.

As shown, the resealable storage bag 100 is 221 mm by 118 mm×22 mm and have a volume of 500 ml (or 16.9 oz.). The storage bag 100 may be held open to at least 85 mm. In other non-limiting embodiments, the storage bag may have larger or smaller dimensions. In other non-limiting embodiments, the storage bag may have a storage capacity of 8 oz., 16 oz., or 32 oz.

The foregoing description has been directed to particular embodiments. However, other variations and modifications may be made to the described embodiments, with the attainment of some or all of their advantages. Modifications to the above-described embodiments may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A food storage bag comprising:
a bag portion configured to receive contents for storage; and
a frame portion configured fasten close the bag portion with an airtight seal;
wherein the bag portion includes a retaining structure configured to securely attach the bag portion to the frame portion, and
wherein the frame portion is configured to securely hold opposing interior sides of the bag portion in order to form the airtight seal.

2. The food storage bag of claim 1, wherein the bag portion comprises silicone and the frame portion comprises Polypropylene plastic.

3. The food storage bag of claim 1, wherein the bag portion comprises at least one graduation mark.

4. The food storage bag of claim 1, wherein the bag portion comprises a viewing window.

5. The food storage bag of claim 1, wherein the bag portion comprises a bottom fold configured to allow the food storage bag to stand up.

6. The food storage bag of claim 1, wherein the frame portion comprises a plurality of hinged elements.

7. The food storage bag of claim 1, wherein the frame portion comprises at least one latch.

8. The food storage bag of claim 7, wherein the at least one latch comprises a protrusion.

9. The food storage bag of claim 8, wherein the frame portion further comprises a recess section configured to operate with the protrusion in order to fasten close the bag portion.

10. The food storage bag of claim 1, wherein the frame portion comprises at least one flexible section.

11. The food storage bag of claim 1, wherein the retaining structure comprises a raised element configured to fit into a recess of the bag portion.

12. The food storage bag of claim 1, wherein the bag portion has a storage capacity of one of: 500 ml, 8 ounces, 16 ounces and 32 ounces.
